(19) United States
(12) Patent Application Publication
(10) Pub. No.: US 2025/0325900 A1
(43) Pub. Date: Oct. 23, 2025

(54) INFORMATION PROCESSING DEVICE, INFORMATION PROCESSING METHOD, AND PROGRAM

(71) Applicant: Sony Interactive Entertainment Inc., Tokyo (JP)

(72) Inventors: Hirotomo YUNOKI, Chiba (JP); Takayuki KATSUMA, Tokyo (JP); Koji HAMADA, Tokyo (JP); Keiji TOGAWA, Tokyo (JP); Yoshio MIYAZAKI, Kanagawa (JP); Kouji KURODA, Kanagawa (JP); Hideki MORI, Tokyo (JP); Yusuke WATANABE, Tokyo (JP)

(73) Assignee: Sony Interactive Entertainment Inc., Tokyo (JP)

(21) Appl. No.: 18/868,180

(22) PCT Filed: Jun. 2, 2022
(86) PCT No.: PCT/JP2022/022493

§ 371 Date: Nov. 22, 2024

(51) Int. Cl. A63F 13/211

(52) U.S. Cl. CPC A63F 13/211

(57) ABSTRACT

Provided is an information processing device that is connected to an operation device having an operation member that can be operated while being tilted and a driving unit for driving the operation member, that accepts operation information including at least one of a tilt direction and tilt angle of the operation member from the operation device, that sets a scene including at least one operation target object to be operated on the basis of the operation information, and that issues a driving instruction to drive the operation member according to a state of the operation target object in the set scene.

### TECHNICAL FIELD

The present invention relates to an information processing device connected to an operation device operated by a user, an information processing method, and a program.

### BACKGROUND ART

An operation device including a tilting operation member that is operated while being tilted by a user, such as an analog stick, has been known. By performing operation inputs to such an operation device, the user can issue an instruction of a direction or the like to an information processing device.

### SUMMARY

### Technical Problem

For example, in a video game or the like, feedback such as presentation of a sense of force is given to a user who operates an operation device in some cases, in order to enhance the sense of presence of the user or to obtain an operation feeling closer to reality. However, what kind of feedback is effective for the user who operates the tilting operation member has not been sufficiently examined.

The present invention has been made in consideration of the above circumstances, and one of the objects thereof is to provide an information processing device, an information processing method, and a program capable of giving effective feedback to a user who operates a tilting operation member.

### Solution to Problem

An information processing device according to an aspect of the present invention is an information processing device that is connected to an operation device having an operation member that can be operated while being tilted and a driving unit for driving the operation member. One or more processors are provided, and the one or more processors accept operation information including at least one of a tilt direction and tilt angle of the operation member from the operation device, set a scene including at least one operation target object to be operated on the basis of the operation information, and issue a driving instruction to drive the operation member, according to a state of the operation target object in the set scene.

An information processing method according to an aspect of the present invention is an information processing method including accepting operation information including at least one of a tilt direction and tilt angle of an operation member, which is able to be operated while being tilted, from an operation device having the operation member and a driving unit for driving the operation member, setting a scene including at least one operation target object to be operated on the basis of the operation information, and issuing a driving instruction to drive the operation member, according to a state of the operation target object in the set scene.

A program according to an aspect of the present invention is a program for causing a computer to execute processes of accepting operation information including at least one of a tilt direction and tilt angle of an operation member from an operation device having the operation member that can be operated while being tilted and a driving unit for driving the operation member, setting a scene including at least one operation target object to be operated on the basis of the operation information, and issuing a driving instruction to drive the operation member, according to a state of the operation target object in the set scene. This program may be provided by being stored in a computer-readable non-transitory information storage medium.

### BRIEF DESCRIPTION OF DRAWINGS

FIG. 1 is a configuration block diagram for depicting a configuration of an information processing device according to an embodiment of the present invention.

FIG. 2 is a diagram for explaining a structure of a tilting operation member.

FIG. 3 is a functional block diagram for depicting functions of the information processing device according to the embodiment of the present invention.

FIG. 4 is a diagram for explaining an example of a driving instruction executed by the information processing device according to the embodiment of the present invention.

FIG. 5 is a diagram for explaining another example of the driving instruction executed by the information processing device according to the embodiment of the present invention.

### DESCRIPTION OF EMBODIMENT

Hereinafter, an embodiment of the present invention will be described in detail on the basis of the drawings.

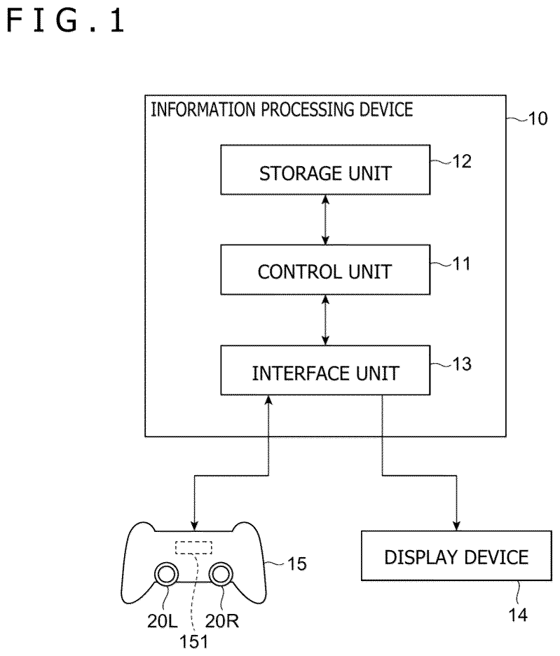

FIG. 1 is a configuration block diagram for depicting a configuration of an information processing device 10 according to an embodiment of the present invention. The information processing device 10 is, for example, a home game machine, a portable game machine, a personal computer, or the like, and includes a control unit 11, a storage unit 12, and an interface unit 13 as depicted in the drawing. In addition, the information processing device 10 is connected to a display device 14 and an operation device 15.

The control unit 11 includes at least one processor such as a central processing unit (CPU), and executes various types of information processing by executing programs stored in the storage unit 12. It should be noted that specific examples of the processing executed by the control unit 11 in the present embodiment will be described later. The storage unit 12 includes at least one memory device such as a random access memory (RAN), and stores programs to be executed by the control unit 11 and data to be processed by the programs.

The interface unit 13 is an interface for data communication between the display device 14 and the operation device 15. The information processing device 10 is connected to each of the display device 14 and the operation device 15 via the interface unit 13 in a wired or wireless manner. Specifically, it is assumed that the interface unit 13 includes a multimedia interface for transmitting a video signal supplied from the information processing device 10, to the display device 14. In addition, it is assumed that the interface unit 13 includes a data communication interface for receiving a signal indicating operation contents performed by a user on the operation device 15. Further, the interface unit 13 may include a communication interface for transmitting and receiving data to/from other communication equipment via a communication network such as the Internet.

The display device 14 is a home television receiver or the like, and displays, on the screen, a video according to the video signal supplied from the information processing device 10.

The operation device 15 is, for example, a controller of a home game machine, and includes a plurality of operation members for accepting operation inputs from the user. In addition, the operation device 15 is connected to the information processing device 10 in a wired or wireless manner, and transmits and receives various types of data to/from the information processing device 10.

The operation device 15 includes a control unit 151 for controlling each part. The control unit 151 includes a microcomputer or the like, scans contents of operation inputs performed by the user on each operation member, and transmits an operation signal indicating the contents to the information processing device 10. In addition, the control unit 151 controls the state of a tilting operation member 20, which will be described later, according to instruction contents accepted from the information processing device 10.

In the present embodiment, the operation device 15 includes the tilting operation member 20 on the surface thereof as a kind of operation member. The tilting operation member 20 is an operation member operated by the user tilting it with a hand or a finger, and is configured to be able to be tilted in any direction of 360 degrees. It should be noted that, as a specific example, it is assumed that the operation device 15 includes two tilting operation members 20 in total, one on the left side and the other on the right side. In the following, in the case where it is necessary to distinguish the left and right tilting operation members 20 from each other, the tilting operation member 20 arranged on the left side of the operation device 15 is written as a tilting operation member 20L, and the tilting operation member 20 on the right side is written as a tilting operation member 20R. In a state where the operation device 15 is gripped with the hands, the user can independently operate the tilting operation member 20L with the left thumb and the tilting operation member 20R with the right thumb.

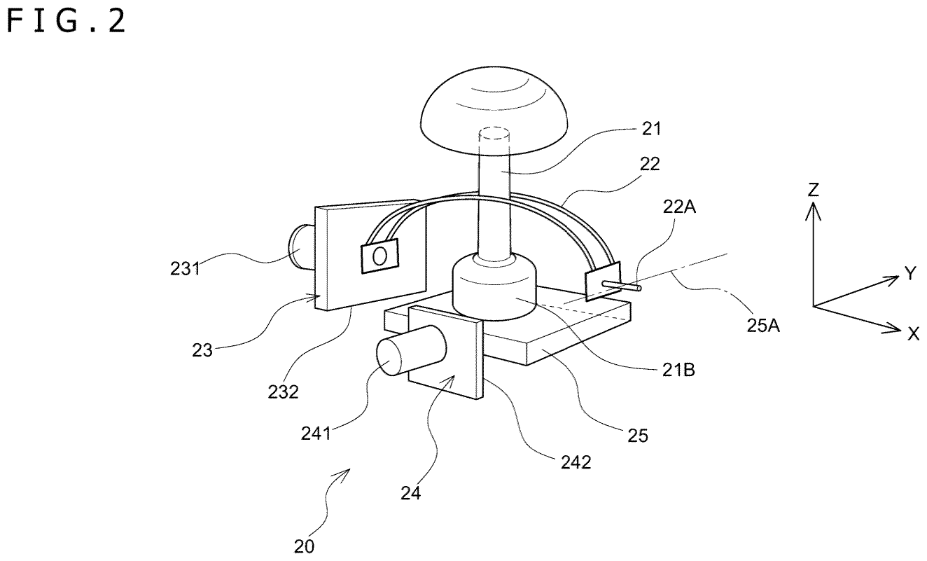

Here, a structure of the tilting operation member 20 will be described. It should be noted that, although the structure of one tilting operation member 20 will be described below, it is assumed that the left and right tilting operation members 20R and 20L have similar configurations. As the outline is exemplified in FIG. 2, the tilting operation member 20 includes a columnar body 21 to be tilted, a guide 22, a first actuator 23, a second actuator 24, and a pedestal 25. It should be noted that it is assumed that the guide 22 and the pedestal 25 are rotatably supported about shafts 22A and 25A, respectively, within at least a predetermined angular range and that the direction of the shaft 22A is an X axis and the direction of the shaft 25A is a Y axis. In addition, it is assumed that a direction orthogonal to both the X axis and the Y axis is a Z axis. That is, the guide 22 rotates in the YZ plane about the shaft 22A. In addition, the pedestal 25 rotates in the XZ plane about the shaft 25A.

The guide 22 restricts the movement of the columnar body 21 in one direction (X axis direction). As described above, the guide 22 is rotatably supported about the shaft 22A within a predetermined angular range in the YZ plane. In addition, it is assumed that the angular range includes an angular range in which the columnar body 21 is parallel to the Z axis direction.

The first actuator 23 and the second actuator 24 function as driving units for driving the columnar body 21, which is a main body part of the tilting operation member 20, according to a control signal accepted from the control unit 151.

Specifically, the first actuator 23 includes a motor 231 and a sensor 232. The motor 231 is, for example, a three-phase brushless direct current (DC) motor (having 3n (n is a natural number) stators), and supplies currents input from the control unit 151, to the stator coils of the respective phases, to control the rotational amount, rotational speed, and rotational direction of the rotor. The rotational shaft of the rotor of the motor 231 is coupled to the shaft 22A of the guide 22, and the motor 231 rotates the guide 22 about the shaft 22A in the YZ plane.

The sensor 232 is, for example, a rotary encoder, a potentiometer, or another angle sensor, and sequentially detects the tilt angle θc of the shaft 22A of the guide 22 with a predetermined reference direction (for example, the direction of the guide 22 in a state where the columnar body 21 can be oriented in the positive direction of the Z axis) as 0 degree, and outputs the detection result to the control unit 151.

The second actuator 24 includes a motor 241 and a sensor 242. Similarly to the motor 231, the motor 241 is, for example, a three-phase brushless DC motor, and supplies currents input from the control unit 151 to the stator coils of the respective phases to control the rotational amount, rotational speed, and rotational direction of the rotor. The rotational shaft of the rotor of the motor 241 is coupled to the shaft 25A of the pedestal 25, and the motor 241 rotates the pedestal 25 about the shaft 25A in the XZ plane.

The sensor 242 is, for example, a rotary encoder, a potentiometer, or another angle sensor, and sequentially detects the tilt angle ϕc of the shaft 25A of the pedestal 25 with a predetermined reference direction (for example, the direction of the pedestal 25 in a state where the columnar body 21 can be oriented in the positive direction of the Z axis) as 0 degree, and outputs the detection result to the control unit 151.

The pedestal 25 is rotatably supported about the shaft 25A within at least a predetermined angular range. In addition, the pedestal 25 supports a base part 21B of the columnar body 21 such that the columnar body 21 is oriented in the positive direction of the Z axis when the rotational angle about the shaft 25A is 0 degree.

It is assumed that the control unit 151 includes a motor driver for controlling the driving of the motor 231 on the basis of the detection result of the sensor 232, and a motor driver for controlling the driving of the motor 241 on the basis of the detection result of the sensor 242. The control unit 151 drives the motor 231 and the motor 241 on the basis of a driving instruction from the information processing device 10, which will be described later, to control to tilt the columnar body 21 in a desired direction or angle, or to change a force required for tilting the columnar body 21 in a given direction. In addition, information for specifying the tilt direction and tilt angle of the columnar body 21 is detected and is periodically transmitted to the information processing device 10 as operation information indicating the contents of an operation performed by the user on the tilting operation member 20.

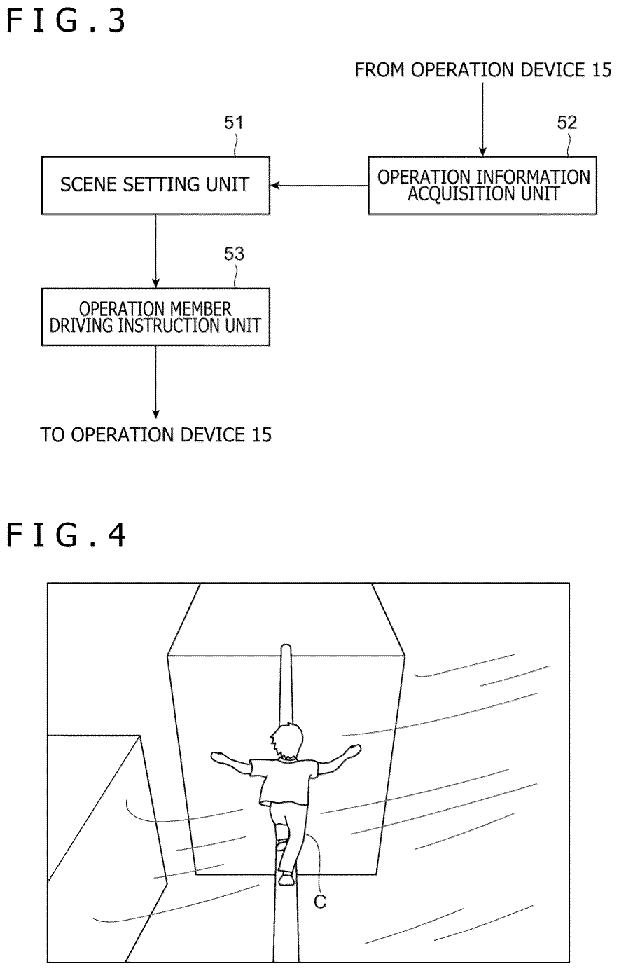

Hereinafter, functions realized by the information processing device 10 will be described using a functional block diagram of FIG. 3. As depicted in FIG. 3, the information processing device 10 functionally includes a scene setting unit 51, an operation information acquisition unit 52, and an operation member driving instruction unit 53. These functions are realized by the control unit 11 operating in accordance with one or more programs stored in the storage unit 12. These programs may be provided to the information processing device 10 via a communication network such as the Internet, or may be stored and provided in a computer-readable information storage medium such as an optical disk.

The scene setting unit 51 sets contents of a scene presented to the user. It is assumed that the scene presented to the user in the present embodiment is a scene depicting a state in a virtual space in which a plurality of virtual objects is arranged. That is, the scene presented to the user is defined by at least the appearances and states of the plurality of virtual objects arranged in the virtual space. Here, the states of the virtual objects may include the positions and orientations of the virtual objects in the virtual space, a change in posture, appearance, and shape, a positional relation with other virtual objects therearound, and the like. The scene setting unit 51 may be realized by, for example, an application program such as a game program.

Specifically, the scene setting unit 51 determines which virtual object is to be arranged in the virtual space and what state each virtual object is in, and draws a spatial image in which the state in the virtual space in which the virtual object is arranged according to the determined contents is viewed from a given viewpoint. The scene setting unit 51 presents the contents of the scene to the user by displaying the spatial image on the screen of the display device 14. The scene setting unit 51 repeatedly executes a process of updating the state of each virtual object arranged in the virtual space, as time elapses, and drawing a spatial image depicting the state every predetermined time.

In particular, in the present embodiment, an operation target object to be operated by the user is arranged in the virtual space. For example, the operation target object may be a character object C representing a user character. The scene setting unit 51 controls the behavior of the operation target object in accordance with operation information acquired by the operation information acquisition unit 52 to be described later. By performing various types of operation inputs to the operation device 15, the user can variously change the state of the operation target object, such as moving the operation target object in the virtual space or exerting some influence on other virtual objects.

The operation information acquisition unit 52 acquires operation information indicating the contents of operation inputs performed by the user on the operation device 15 from the operation device 15. It is assumed that the operation information includes at least one of a tilt direction (namely, the direction in which the columnar body 21 is tilted with respect to the reference position) and a tilt angle (namely, the angle at which the columnar body 21 is tilted) as information indicating the operation contents of each of the plurality of tilting operation members 20. The scene setting unit 51 updates the contents of the scene presented to the user, on the basis of the operation information accepted by the operation information acquisition unit 52. In particular, in the present embodiment, it is assumed that the scene setting unit 51 updates the state of the operation target object on the basis of the operation contents executed by the user on the tilting operation member 20. In addition, the operation information acquired by the operation information acquisition unit 52 may be referred to in order to determine the instruction contents transmitted by the operation member driving instruction unit 53 to be described later.

The operation member driving instruction unit 53 instructs the tilting operation member 20 to be driven, according to the state of the operation target object determined by the scene setting unit 51. Specifically, the operation member driving instruction unit 53 determines the contents of the driving instruction for each of the left and right tilting operation members 20L and 20R according to the state of each virtual object determined by the scene setting unit 51. Then, a control signal including the contents of the driving instruction is transmitted to the operation device 15. The control unit 151 of the operation device 15 drives the first actuator 23 and the second actuator 24 provided in each of the left and right tilting operation members 20 according to the instruction accepted from the operation member driving instruction unit 53. Accordingly, the information processing device 10 according to the present embodiment can drive the tilting operation member 20 so as to respond to the state of the operation target object, and present a sense of force or the like matching the contents of the scene to the user who operates the tilting operation member 20.

Hereinafter, some specific examples of the driving contents determined by the operation member driving instruction unit 53 will be described.

As a first example, the operation member driving instruction unit 53 may execute a driving instruction to drive the tilting operation member 20 in a direction according to the direction of the force applied to the operation target object in order to express the force received by the operation target object in the virtual space.

FIG. 4 is a diagram for explaining a specific example of such a driving instruction, and depicts a state in which a character object C, which is an operation target object, crosses an elongated scaffold in a virtual space. In the example of the drawing, it is assumed that the wind blows in the space where the character object C is located, and that the character object C receives a force to leeward due to the wind. In order to express the force to be received due to the wind, the operation member driving instruction unit 53 issues a driving instruction to tilt the columnar body 21 in a direction corresponding to the lee.

Specifically, the operation member driving instruction unit 53 controls to tilt the columnar body 21 to the left direction when the wind blows from the right direction with respect to the front of the character object C, and controls to tilt the columnar body 21 to the right direction when the wind reversely blows from the left direction. Further, in this example, it is assumed that the scene setting unit 51 determines the character object C so as to be linked with the state of the tilting operation member 20 determined by both the driving instruction by the operation member driving instruction unit 53 and the operation by the user. If the user does not perform any operation on the columnar body 21, the columnar body 21 is largely tilted in the leeward direction according to the driving instruction, and the character object C falls from the scaffold while being linked with this. Therefore, the user is required not only to tilt the columnar body 21 in the direction in which the character object C is to be advanced, but also to operate the columnar body 21 against the direction of the driving instruction by the operation member driving instruction unit 53 such that the columnar body 21 is not largely tilted in the left and right directions. Accordingly, not only a sense of force is presented to the user, but also the operation according to the contents of the force received by the character object C can be requested for the user, and the experience in the virtual space can be further improved.

It should be noted that the operation member driving instruction unit 53 may change the amount of movement, the moving speed, the magnitude of torque, and the like of the columnar body 21 according to the magnitude of the force received by the operation target object. For example, in the example of FIG. 4, it is assumed that the strength of the wind blowing in the virtual space changes according to the difficulty setting of the game, or the like. At this time, as the wind is stronger, a stronger force is applied to the character object C. Thus, the operation member driving instruction unit 53 issues a driving instruction such that the magnitude of the force required to move the columnar body 21 against the direction of the wind is a magnitude according to the strength of the wind. The control unit 151 performs the driving control according to such a driving instruction, so that the user can experience the strength of the wind in the virtual space and can change the degree of difficulty of the operation to be performed by the user against the wind.

As a second example, when the operation target object exerts a force on another object according to the operation of the user on the tilting operation member 20, the operation member driving instruction unit 53 may issue a driving instruction to present the reaction or resistance force thereof. In the first example, the driving instruction to tilt the columnar body 21 is issued regardless of the presence or absence of the operation by the user, but unlike this, in the case where the user performs an operation of tilting the columnar body 21, an instruction to perform driving control of the contents according to the tilting operation is issued in the second example.

Specifically, when the operation target object exerts a force on another object therearound, the operation member driving instruction unit 53 issues a driving instruction to present a resistance force against a tilting operation toward the object. In response to this, the control unit 151 of the operation device 15 performs torque control such that, when the user performs a tilting operation in a specified direction, a stronger force is required for the operation. This requires the user to perform a tilting operation with a stronger force in a specific direction.

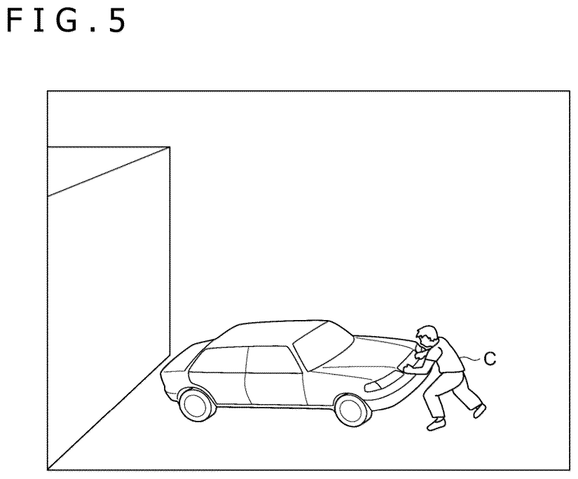

FIG. 5 is a diagram for depicting a specific example of such control, and depicts a state in which the character object C, which is an operation target object, pushes an automobile object. In the example of the drawing, the user performs an operation of tilting the tilting operation member 20 to the left direction to move the character object C to the left direction. Accordingly, the character object C performs an operation of pushing and moving the automobile object. At this time, the character object C receives a force by reaction from the automobile object, and the magnitude of the force becomes larger as the automobile object is heavier. Thus, in order to express such a force, when the user performs an operation of tilting the columnar body 21 to cause the character object C to push the automobile object, the operation member driving instruction unit 53 issues a driving instruction to generate a resistance force against the operation. It should be noted that, in order to express friction, a stronger resistance force may be generated until the automobile object starts to move, and the magnitude of the resistance force may be reduced after the automobile object starts to move. Accordingly, it can be expressed that a stronger force is required when the automobile object starts to move than after the automobile object starts to move because a stronger frictional force is generated in a state where the automobile object is stationary.

Further, in the case where the moving automobile object collides with a wall, or the like, the automobile object stops, and a strong repulsive force is applied to the character object C. In this case, the operation member driving instruction unit 23 may present, to the user, an impact generated on the character object C when the automobile object collides with the wall, by momentarily performing driving control to largely move the columnar body 21 in the direction opposite to the moving direction of the automobile object so far.

In addition, as another example, in the case where the operation inputs to the left and right tilting operation members 20 are assigned to different operation targets, such as a case in which operations on the left and right tilting operation members 20 by the user are reflected in operations of the left and right hands of the character object C, the operation member driving instruction unit 53 may issue driving instructions, which are different from each other, to the left and right tilting operation members 20.

As a specific example, when the character object C holds a bow and performs an operation of drawing the bow, forces applied to the right and left hands of the character object C by the elasticity of the bow may be presented to the user. In the case where a person holds the main body of a bow with the left hand and holds an arrow with the right hand to draw the bow, the person aims by moving the left hand and moves the right hand to the direction away from the left hand. The user can cause the character object C to execute such an operation by using the right and left tilting operation members 20.

Specifically, it is assumed that the user moves the left tilting operation member 20L in the left and right directions to change the direction in which the user aims with the arrow and also moves the right tilting operation member 20R in the front direction (lower direction in plan view) to draw the bow. At this time, the operation member driving instruction unit 53 generates a repulsive force against the operation in the front direction to the right tilting operation member 20R. That is, while the user performs an operation of tilting the right tilting operation member 20R to the front direction, a resistance force against the operation is generated. Accordingly, the user can feel a force due to the elasticity of the string when performing an operation of drawing the bow.

In addition, while the user performs an operation of drawing the bow, the operation member driving instruction unit 53 may generate a force toward the front direction not only to the right tilting operation member 20R but also to the left tilting operation member 20L. This is a driving instruction to generate a force to the left tilting operation member 20L, which is different from the right tilting operation member 20R, while being linked with the operation on the right tilting operation member 20R. The user applies a force so as to tilt the left tilting operation member 20L in the depth direction against this force and simultaneously operates the tilting operation member 20L in the left and right directions to aim the bow. Accordingly, the user can perform an operation of drawing the bow while feeling the forces applied to the right and left hands in directions opposite to each other due to the elasticity of the string. Once the target is set, the user performs an operation of shooting the arrow. This operation may be, for example, an operation of releasing the right tilting operation member 20R by lifting the finger, or an operation on other operation buttons.

In this way, by issuing driving instructions, which are different from each other, to the right and left tilting operation members 20, a sense of force according to the state of each of the right and left hands can be presented to the user.

In addition, as another example, even in the case where the operation target object does not directly exert a force on another virtual object, and in the case where the state of another virtual object changes under the influence of the behavior of the operation target object, the operation member driving instruction unit 53 may issue a driving instruction to change the state of the tilting operation member 20 so as to express the change of the state.

As an example, an example in which the scene setting unit 51 presents the user a scene in which the operation target object is a tray and a cup containing water is placed thereon will be described. In this example, the user performs an operation of tilting the operation device 15 itself to change the orientation of the tray. In order to realize such an operation, it is assumed that a posture sensor such as an acceleration sensor is incorporated in the operation device 15 and that the operation information acquisition unit 52 acquires the detection result thereof as operation information. In this case, the operation member driving instruction unit 53 issues a driving instruction to tilt the tilting operation member 20 in the direction opposite to the tilt of the main body of the operation device 15. Accordingly, the tilting operation member 20 can be driven such that the columnar body 21 always faces vertically upward even when the user tilts the operation device 15. In this example, the orientation of the columnar body 21 is linked with the surface (water surface) of the water contained in the cup in the scene presented to the user.

As a third example, in the case where the behavior of the operation target object in the virtual space is limited, the operation member driving instruction unit 53 may issue a driving instruction to restrict the movable range of the tilting operation member 20 so as to be linked with the limitation. For example, in the case where the operation target object is a lever or the like, there is a case where only an operation along a predetermined direction is possible. As an example, in the case where the operation target object can move in the front and rear directions in the virtual space but cannot move in the left and right directions, the operation member driving instruction unit 53 issues a driving instruction to restrict the tilting operation itself in the left and right directions. In response to this, the control unit 151 of the operation device 15 performs torque control such that a very large force is required for the tilting operation of the tilting operation member 20 in the left and right directions. Accordingly, the user cannot perform an operation of tilting the columnar body 21 in the left and right directions, and can perform only an operation according to the state of the character object C.

As another example, it is assumed that the operation target object is an oar of a boat, and that the user performs an operation such that the tilting operation member 20 is rotated to pull the oar. In this case, the user performs an operation of tilting the columnar body 21 by a predetermined angle or more and rotating the columnar body 21 in a predetermined direction while maintaining the tilting. At this time, the operation member driving instruction unit 53 may issue a driving instruction to allow the user to perform only the operation of rotating the columnar body 21.

The control unit 151 of the operation device 15 that has received the driving instruction performs control for restricting movement in a predetermined direction according to the state (the tilt direction and/or tilt angle of the tilting operation member 20) of the tilting operation member 20. Specifically, in a state where the columnar body 21 is tilted by a predetermined angle or more, in order to restrict movement in a direction in which the angle becomes smaller (returning to the central reference position), the force required for the operation in the direction to be restricted is increased. Accordingly, the user can smoothly perform an operation of rotating the columnar body 21.

In this example, the direction to be restricted is the direction to return to the center, but the direction itself changes depending on the position of the columnar body 21. For example, in a state where the columnar body 21 is tilted to the left direction, the operation to the right direction is restricted, and in a state where the columnar body is tilted to the right direction, the operation to the left direction is restricted. Therefore, the control unit 151 changes the contents of the torque control according to the current position of the columnar body 21. The contents of such control according to the position of the columnar body 21 may be accepted in advance from the operation member driving instruction unit 53. In this case, the operation member driving instruction unit 53 transmits a driving instruction including a combination of the position of the columnar body 21 and the contents of the driving control at the position to the operation device 15, and the control unit 151 performs control according to the detection results of the sensors 232 and 242 on the basis of the contents of the driving instruction until a new driving instruction is accepted. Alternatively, on the basis of the operation information (the operation information includes information indicating the current position of the columnar body 21) accepted by the operation information acquisition unit 52, the operation member driving instruction unit 53 may issue a driving instruction including information of the direction in which the operation should be restricted at that time. In this case, it is assumed that, each time the driving instruction is accepted, the control unit 151 performs the torque control for limiting the movement in the direction included in the instruction.

In addition, although only the tilting operation in a specific direction is restricted in the above description, the present invention is not limited to this, and the operation member driving instruction unit 53 may issue a driving instruction to limit the angle of the tilting operation. For example, in the case where the operation target object can be moved in a specific direction in the virtual space but the moving range thereof is limited, the operation member driving instruction unit 53 issues a driving instruction to limit the angle range within which the tilting operation is possible so as to be linked with the moving range. Accordingly, it is possible to limit the tilting operation according to the state of the operation target object, for example, by limiting the angle at which the tilting operation in the left and right directions can be performed, to 10° in the case where the operation target object is in a specific state, while enabling the tilting operation in the upper and lower directions up to 20°.

As a fourth example, the operation member driving instruction unit 53 may issue a driving instruction according to the operation contents to be performed by the user. For example, in a shooting game or the like, in order for the user to shoot a target place with a gun, there is a case where the user operates the tilting operation member 20 and moves an aiming mark to aim and performs an operation of firing the gun at the timing when the target is set. In this example, the aiming mark is the operation target object by the tilting operation member 20. In this example, the user needs to precisely operate the tilting operation member 20 to accurately align the aiming mark with the target. Therefore, in order to assist such an aiming operation, there is a case where a function is implemented to automatically align the aiming mark with the target when the user moves the aiming mark close to the target object to some extent, or to automatically move the aiming mark while being linked with the movement of the target.

In the case where the scene setting unit 51 moves the aiming mark by such a function, the operation member driving instruction unit 53 may drive the tilting operation member 20 according to the movement of the aiming mark. Specifically, in the case where the aiming mark is automatically moved without the operation of the user, the operation member driving instruction unit 53 actually drives the tilting operation member 20 similarly to a case where the movement is realized by the operation of the user. Accordingly, the user can not only receive assistance for the aiming operation, but also can sensuously grasp what assistance has been given and what operation should have been performed in the case of no assistance.

In this example, the scene setting unit 51 executes a process of updating the contents of the scene as if the operation contents originally to be performed by the user had been performed even though the operation contents was not actually performed, and automatically moves the aiming mark as the operation target object. Then, the operation member driving instruction unit 53 performs driving control for reproducing the operation contents for moving the aiming mark so as to be linked with the movement of the aiming mark.

As a fifth example, the operation member driving instruction unit 53 may perform driving control according to the operation contents recorded in advance or the operation contents performed in real time by another user. As a specific example, it is assumed that the operation information acquisition unit 52 accepts and records the operation contents executed by someone on the tilting operation member 20 in advance in a particular scene. Then, the operation member driving instruction unit 53 executes driving control for reproducing the operation contents according to an instruction of the user or the like. At this time, the scene setting unit 51 updates the contents of the scene such that the operation target object performs a behavior according to the recorded operation contents. Accordingly, the information processing device 10 reproduces the operation contents performed by another user while presenting, to the user, the same scene as when the operation contents is recorded, so that the user can experience, for example, the situation of a game actually played by another person including the operation contents.

In addition, the operation member driving instruction unit 53 may perform driving control for reproducing, in real time, the operation contents executed by another user for another operation device 15. In this example, it is assumed that two operation devices 15 are connected to the information processing device 10 and that each device is used by another user. In this example, the operation information acquisition unit 52 acquires operation information indicating the operation contents on the tilting operation member 20 from one operation device 15. Then, the operation member driving instruction unit 53 transmits, to the other operation device 15, a driving instruction to cause the tilting operation member 20 provided in the operation device 15 to perform movement linked with the operation contents acquired by the operation information acquisition unit 52. Accordingly, while two users browse the same screen, one user can experience the operation contents performed by the other user on the tilting operation member 20.

In either case, similarly to the fourth example, the user of the operation device 15 to which the driving instruction is issued can sensuously grasp the contents of the operation that the user has not performed. In addition, since the scene setting unit 51 updates the contents of the scene so as to be linked with the operation contents, the user can experience the presented scene and the operation contents for realizing the scene together.

It should be noted that the operation member driving instruction unit 53 may change the magnitude of the force presented to the user by driving the tilting operation member 20 in the above description according to the user who uses the operation device 15. For example, as in the second example described above, in the case where the operation member driving instruction unit 53 issues an instruction to present a force against the tilting operation of the user, there is a case where it becomes difficult for a person such as a child or a woman whose strength of hands and fingers is relatively small to perform the tilting operation against the presented force. Therefore, it is assumed that the operation member driving instruction unit 53 changes the magnitude of the force to be presented, depending on which the user is actually using the operation device 15. Thus, in the case where a user with a weak force is using the device, the presented force is corrected to be small, so that the user can easily perform the tilting operation while receiving the force, even in the case where the force against the operation of the user is presented.

As a specific example, it is assumed that the user who uses the information processing device 10 performs user registration in advance and performs a login operation when starting to use the information processing device 10. In this case, the information processing device 10 holds information (correction information) for specifying the correction contents of the presented force for each registered user. The correction information may be information specified by each user by performing a selection operation in advance. The operation member driving instruction unit 53 determines the magnitude of the presented force with reference to the correction information held in association with the user who is currently logging in. Specifically, first, the operation member driving instruction unit 53 determines a reference value of the magnitude of the resistance force to be presented, according to the kind of object on which the operation target object exerts a force. Then, the determined reference value is corrected according to the correction information associated with the logged-in user, and the operation device 15 is instructed to present a resistance force against the tilting operation of the user with the corrected magnitude. For example, in the case where the correction information is information indicating the correction contents of the three stages of “no correction,” “slightly weaker,” and “weaker,” the operation member driving instruction unit 53 instructs the operation device 15 to present the resistance force of the magnitude corresponding to the determined reference value as it is, if the correction information is “no correction.” On the other hand, if the correction information associated with the logged-in user is “slightly weaker,” the determined reference value is reduced by a predetermined amount to determine the magnitude of the resistance force to be presented, and if the correction information is “weaker,” the reference value is corrected to be much smaller than the case of “slightly weaker” to determine the magnitude of the resistance force to be presented.

In addition, the operation member driving instruction unit 53 may determine the correction contents for the magnitude of the presented force on the basis of profile information of the logged-in user. In this case, it is assumed that each user registers his/her gender, age, and the like as a part of the profile information in advance. The operation member driving instruction unit 53 determines a correction amount for the magnitude of the presented force by referring to the profile information. Thus, even in the case where the user does not individually specify the correction contents, the correction can be made according to the attribute of the user.

In addition, the operation member driving instruction unit 53 may acquire a history of the past operation contents of the user and change the magnitude of the presented force according to the contents. In general, it is assumed that the operation amount of the tilting operation by the user becomes small or the operation speed becomes slow while the resistance force against the tilting operation is presented. Then, the tendency of such a change in the operation contents is considered to be different for each user. That is, it is assumed that a person with a weaker strength of the hands and fingers has a great impact on the operation contents while the resistance force is presented. Therefore, the operation member driving instruction unit 53 may acquire a history of past tilting operations performed by the user for each user and analyze the contents thereof to determine the correction amount for the magnitude of the presented force thereafter. It should be noted that such a determination process of the correction amount may be realized by a machine learning process using a history of past tilting operations as an input. Accordingly, the correction process of contents suitable for each user can be performed without accepting designation of the correction contents from the user.

In addition, the operation member driving instruction unit 53 may change the values of various types of parameters included in the contents of the driving instruction to the tilting operation member 20, such as the amount of movement, the moving speed, and the magnitude of torque when the tilting operation member 20 is moved, as well as the magnitude of the resistance force presented to the tilting operation by the user, according to the user who is operating the operation device 15.

As described above, according to the information processing device 10 according to the present embodiment, by issuing a driving instruction to the tilting operation member 20 according to the state of the operation target object in the virtual space, effective feedback can be given to the user who operates the operation target object by using the tilting operation member 20.

It should be noted that the embodiment of the present invention is not limited to that described above. For example, the operation target object and the contents of the driving instruction according to the state thereof in the above description are merely examples, and the operation target object may be various virtual objects to be operated by the user.

In addition, the operation device 15 is not limited to a device held and used by the user, and may be a device used in a state where it is placed on a table or the like. In addition, the tilting operation member 20 is not limited to an operation member operated with the thumb of the user, and may be an operation member having various types of shapes and structures, such as an operation member operated with other fingers or an operation member operated in a state where the user grips it with a hand.

In addition, in the above description, the information processing device 10 is directly connected to the display device 14 and the operation device 15 and is used at a position relatively close to the user. However, the present invention is not limited to this, and the information processing device 10 according to the embodiment of the present invention may be a server device connected to the display device 14 and the operation device 15 via a communication network such as the Internet. In this case, the display device 14 and the operation device 15 are directly connected to a client device used by the user, and the information processing device 10 is connected to the client device via a communication network. Then, the information processing device 10 accepts the operation information transmitted via the client device and issues a driving instruction to the operation device 15 via the client device.

### REFERENCE SIGNS LIST

10: Information processing device
11: Control unit
12: Storage unit
13: Interface unit
14: Display device
15: Operation device
151: Control unit
20: Tilting operation member
21: Columnar body
22: Guide
23: First actuator
24: Second actuator
25: Pedestal
51: Scene setting unit
52: Operation information acquisition unit
53: Operation member driving instruction unit

1. An information processing device that is connected to an operation device having an operation member that is able to be operated while being tilted and a driving unit for driving the operation member, wherein
one or more processors are provided, and
the one or more processors
accept operation information including at least one of a tilt direction and tilt angle of the operation member from the operation device,
set a scene including at least one operation target object to be operated on a basis of the operation information, and
issue a driving instruction to drive the operation member, according to a state of the operation target object in the set scene.

2. The information processing device according to claim 1, wherein
the one or more processors issue a driving instruction to drive the operation member in a direction according to a direction of a force received by the operation target object in the scene.

3. The information processing device according to claim 2, wherein
the one or more processors update contents of the scene according to a state of the operation member driven by the driving instruction.

4. The information processing device according to claim 1, wherein,
in a case where the operation target object exerts a force on another object in the scene on the basis of the operation information, the one or more processors issue a driving instruction to present a resistance force against a tilting operation on the operation member.

5. The information processing device according to claim 1, wherein
the one or more processors issue a driving instruction to limit at least one of the tilt direction and tilt angle of the operation member according to the state of the operation target object in the scene.

6. The information processing device according to claim 5, wherein
the one or more processors issue a driving instruction to change contents of the limitation to the operation member according to a state of the operation member.

7. The information processing device according to claim 1, wherein,
in a case where the state of the operation target object is changed without depending on the operation information, the one or more processors issue a driving instruction to drive the operation member, according to operation contents on the operation member for causing the change.

8. The information processing device according to claim 1, wherein
the one or more processors issue a driving instruction to drive the operation member, according to operation contents on the operation member, which are recorded in advance, and update contents of the scene according to the recorded operation contents.

9. The information processing device according to claim 1, wherein
the one or more processors issue a driving instruction to drive the operation member, according to operation contents on a tilting operation member provided in an operation device different from the operation device, and update contents of the scene according to the operation contents on the different operation device.

10. The information processing device according to claim 1, wherein
the one or more processors change values of parameters included in contents of the driving instruction according to a user who uses the operation device.

11. An information processing method comprising:
accepting operation information including at least one of a tilt direction and tilt angle of an operation member, which is able to be operated while being tilted, from an operation device having the operation member and a driving unit for driving the operation member,
setting a scene including at least one operation target object to be operated on a basis of the operation information, and
issuing a driving instruction to drive the operation member, according to a state of the operation target object in the set scene.

12. A program for a computer, comprising:
by one or more processors,
accepting operation information including at least one of a tilt direction and tilt angle of an operation member from an operation device having the operation member that is able to be operated while being tilted and a driving unit for driving the operation member;
setting a scene including at least one operation target object to be operated on a basis of the operation information; and
issuing a driving instruction to drive the operation member, according to a state of the operation target object in the set scene.
